(19) United States
(12) Patent Application Publication
(10) Pub. No.: US 2012/0224110 A1
(43) Pub. Date: Sep. 6, 2012

(54) PROJECTION DISPLAY DEVICE

(76) Inventor: Naoki KAWAMOTO, Tokyo (JP)

(21) Appl. No.: 13/402,673

(22) Filed: Feb. 22, 2012

(30) Foreign Application Priority Data
Mar. 1, 2011 (JP) JP2011-043451

(51) Int. Cl. H04N 9/31

(52) U.S. Cl. 348/760; 348/E09.025

(57) ABSTRACT

A projection display device of the present invention comprises a light source, a DMD chip for modulating emitted light in response to an input signal, an illumination optical system for emitting light from the light source to the DMD chip, a projection lens for projecting light modulated by the DMD chip onto a screen, and a photosensor disposed on an optical path of branch light which is branched outside of a main optical path from the light source to the screen, in the vicinity of a position which is optically conjugate to a screen surface of the screen. With this constitution, it is possible to provide a projection display device which is capable of accurately detecting a luminance change and a hue change on a screen surface without interfering with any display video image.

### BACKGROUND OF THE INVENTION

1. Field of the Invention

The present invention relates to a projection display device, and more particularly to a projection display device which incorporates a photosensor for detecting luminance and hue and has a function of correcting the luminance and the hue.

2. Description of the Background Art

Conventionally, projection display devices detect a luminance change and a hue change on a screen surface, which are caused by changes in brightness and tint of a light source, by using an incorporated photosensor and controls outputs of video signals, to thereby correct the luminance change and the hue change (see Japanese Patent Application Laid Open Gazette No. 2010-210742 (Patent Document 1) and Patent Publication No. 4404613 (Patent Document 2).

Since the amount of change in brightness of the light source and the amount of change in luminance of the screen do not always coincide with each other, however, there has been a problem that the luminance change and the hue change detected by the incorporated photosensor are different from the luminance change and hue change on the screen surface and it is therefore impossible to appropriately correct the luminance and the hue.

A projector shown in Patent Document 1 detects leak light from an optical path by using a photosensor, to thereby detect deterioration of a lamp, but cannot precisely measure the luminance on the screen.

On the other hand, in Patent Document 2, since the measurement is performed with a photosensor covering a projection lens of a projector, it is possible to measure a luminance change and the like on a screen surface with high accuracy, but it is disadvantageous that any image cannot be displayed during the measurement.

### SUMMARY OF THE INVENTION

It is an object of the present invention to provide a projection display device which is capable of accurately detecting a luminance change and a hue change on a screen surface without interfering with any display video image.

The present invention is intended for a projection display device. According to a first aspect of the present invention, the projection display device includes a light source, a light modulator, an illumination optical system, a projection optical system, and a photosensor. The light modulator modulates emitted light in response to an input signal. The illumination optical system emits light from the light source to the light modulator. The projection optical system projects light modulated by the light modulator onto a screen. The photosensor is disposed on an optical path of branch light which is branched outside of a main optical path from the light source to the screen, in the vicinity of a position which is optically conjugate to a screen surface of the screen.

In the projection display device according to the first aspect of the present invention, since the photosensor is disposed in the vicinity of the position which is optically conjugate to the screen surface of the screen, it is possible to accurately detect a luminance change and a hue change on the screen surface. Further, since the photosensor is disposed on the optical path of the branch light which is branched outside of the main optical path from the light source to the screen, it is possible to detect a luminance change and a hue change on the screen surface without interfering with any display video image.

According to a second aspect of the present invention, the projection display device includes a light source, a light modulator, an illumination optical system, a projection optical system, uniformizing means, and a photosensor. The light modulator modulates emitted light in response to an input signal. The illumination optical system emits light from the light source to the light modulator. The projection optical system projects light modulated by the light modulator onto a screen. The uniformizing means uniformizes a luminance distribution of branch light branched outside of a main optical path from the light source to the screen. On the photosensor, light uniformized by the uniformizing means is incident.

Since the projection display device according to the second aspect of the present invention includes the uniformizing means for uniformizing the luminance distribution of the branch light branched outside of the main optical path from the light source to the screen and the photosensor on which light uniformized by the uniformizing means is incident, it is possible to accurately detect a luminance change and a hue change on the screen surface without interfering with any display video image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a structural diagram showing a projection display device in accordance with a first preferred embodiment of the present invention;

FIGS. 2A and 2B are views showing a correspondence relation between a color wheel and a video signal in accordance with the first preferred embodiment;

FIGS. 3A and 3B are views showing a luminance distribution of source light on a light outgoing section of an integrator;

FIG. 4 is a view for explanation on a luminance change of the source light on the light outgoing section of the integrator in a case where the brightness of a light source changes;

FIGS. 5A and 5B are views for explanation on a luminance change of the source light on the light outgoing section of the integrator in a case where a light source image becomes larger;

FIGS. 6A and 6B are views for explanation on a luminance change of the source light on the light outgoing section of the integrator in a case where a light source position is shifted;

FIG. 7 is a view for explanation on an optically conjugate relation in the projection display device in accordance with the first preferred embodiment;

FIGS. 8A and 8B are views showing a relation of luminance distributions at optically conjugate positions;

FIG. 9 is a structural diagram showing a projection display device in accordance with a second preferred embodiment of the present invention;

FIG. 10 is a structural diagram showing a projection display device in accordance with a third preferred embodiment of the present invention;

FIG. 11 is a structural diagram showing a projection display device in accordance with a variation of the third preferred embodiment;

FIG. 12 is a structural diagram showing a projection display device in accordance with a fourth preferred embodiment of the present invention; and

FIG. 13 is a structural diagram showing a projection display device in accordance with a fifth preferred embodiment of the present invention.

### DESCRIPTION OF THE PREFERRED EMBODIMENTS

### The First Preferred Embodiment

### <Constitution>

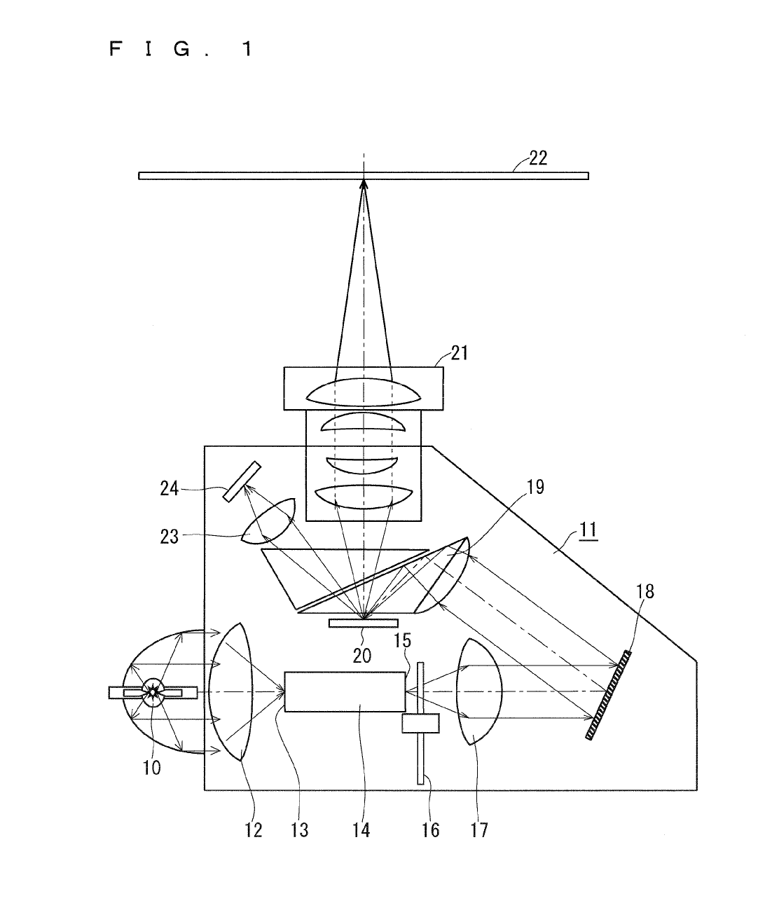

FIG. 1 is a structural diagram showing a projection display device in accordance with the first preferred embodiment of the present invention. The projection display device of the first preferred embodiment comprises a lamp light source 10, a projector unit 11 for modulating source light of the lamp light source 10 in response to a video signal, and a projection lens 21 for projecting light modulated by the projector unit 11 onto a screen 22.

The projector unit 11 comprises a condenser lens 12 for condensing light from the lamp light source 10 onto an integrator light incident surface 13, an integrator 14 for uniformizing a luminance distribution of the light, a color wheel 16 for extracting the three primary color components of light, a DMD chip 20 serving as a light valve, and a relay lens 17 for imaging outgoing light from the integrator 14 on the DMD chip 20.

The source light emitted from the lamp light source 10 is condensed by the condenser lens 12 onto the integrator light incident surface 13 and captured in the integrator 14. The light captured in the integrator 14 is totally reflected repeatedly inside the integrator 14 and the luminance distribution thereof is uniformized in an integrator light outgoing surface 15.

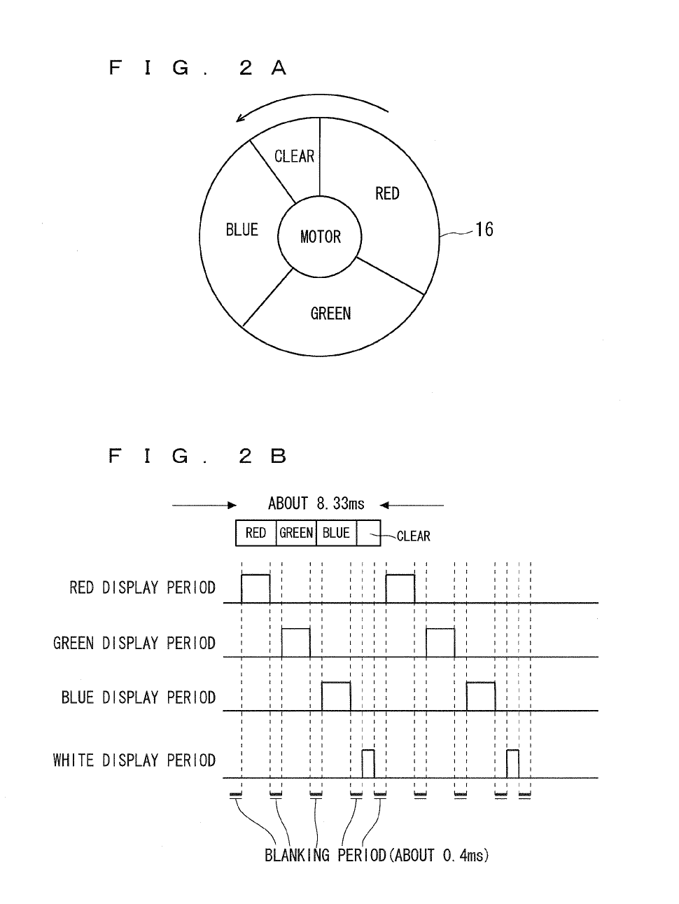

The color wheel 16 is a rotating plate having red, green, blue, and clear filters (FIG. 2A). Out of the light outgoing from the integrator light outgoing surface 15, only a component of the same color as that of each filter passes through the color wheel 16, and therefore light of red, green, blue, and white are generated in sequence.

The light passing through the color wheel 16 is imaged on the DMD chip 20 through the relay lens 17. The luminance distribution on the DMD chip 20 is uniform like on the integrator light outgoing surface 15. From the relay lens 17 to the DMD chip 20, the optical path is folded by a reflection mirror 18 and an internal total reflection prism 19. In the DMD chip 20, the inclination of a micromirror is changed in response to an input signal and the light is modulated into on light and off light for each of the colors corresponding to the filters of the color wheel 16. The on light is outputted to the projection lens 21 and a video image is projected onto a screen surface of the screen 22.

On the other hand, the off light goes towards such a direction as not to enter the projection lens 21. The projector unit 11 comprises a photosensor imaging lens 23 and a photosensor 24 on an optical path of the off light, and the photosensor imaging lens 23 images the off light of the DMD chip 20 on the photosensor 24, and the photosensor 24 thereby detects a luminance change and a hue change on the screen 22.

### <Photosensor>

FIGS. 2A and 2B are views showing a correspondence relation between the rotation of the color wheel 16 and a video signal. When the color of the filter of the color wheel 16 changes, a blanking period in which an entire screen is displayed in black occurs. If the color wheel 16 rotates at 120 Hz, for example, the time required of the color wheel 16 to rotate one revolution is about 8.33 ms and the blanking period is about 0.4 ms. During the blanking period, full black signals are displayed on the screen 22 while the photosensor 24 acquires a value.

Thus, in the projection display device of the first preferred embodiment, when the optical path from the lamp light source 10 to the screen 22 is assumed to be a main optical path, by disposing the photosensor 24 on the optical path of branch light branched from the main optical path, it becomes possible for the photosensor 24 to perform a measurement without interfering with any display video image.

The photosensor 24 acquires all the luminances of red, green, blue, and white and corrects the luminance and hue. Alternatively, the photosensor 24 may acquire a photosensor value of only white or only green and correct only the luminance. With the photosensor value acquired at the initial time of use of the lamp light source 10 as a reference, the changes in luminance and hue with time are acquired.

The photosensor 24 may be a single color luminance sensor or a color sensor (for example, a three color sensor for red, green, and blue), or may be a spectral sensor for measuring the intensity of light by wavelength. When a single color luminance sensor is used as the photosensor 24, only the luminance change may be corrected, or both the luminance and the hue may be corrected by measuring the respective luminances of red, green, and blue. When a color sensor or a spectral sensor is used as the photosensor 24, it is possible to correct both the luminance and the hue.

### <Luminance Change>

Next, discussion will be made on the change in brightness of the lamp light source 10 and the change in luminance of a video image projected on the screen 22.

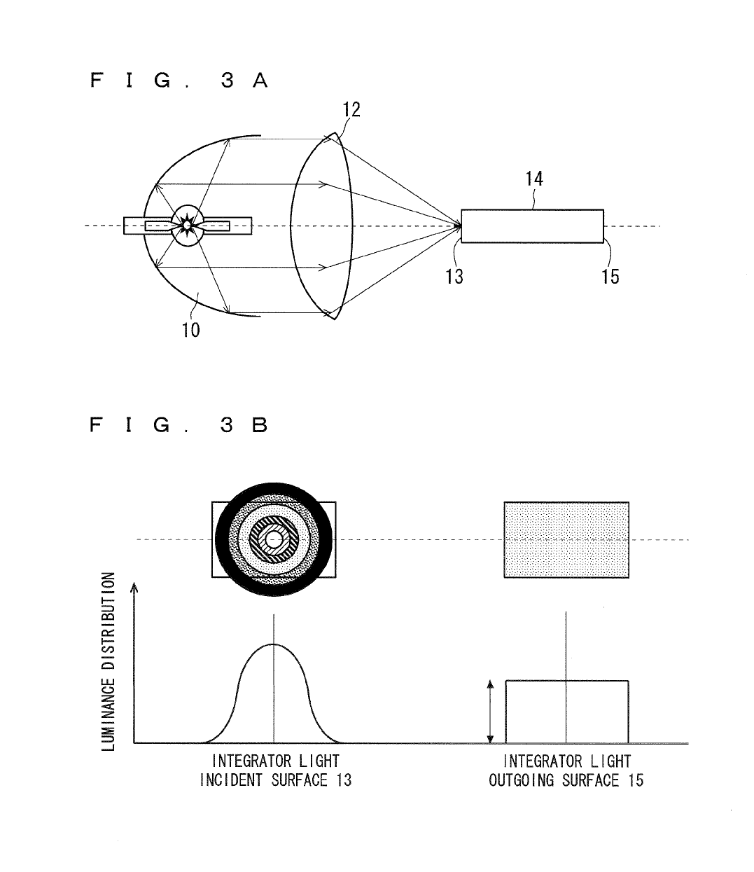

As shown in FIG. 3A, the light outgoing from the lamp light source 10 is condensed by the condenser lens 12 onto the integrator light incident surface 13. The upper view of FIG. 3B shows respective luminance distributions on the integrator light incident surface 13 and the integrator light outgoing surface 15, and the lower view shows the respective luminance distributions taken along the dotted line of the upper view.

Since the light is condensed in circle with the integrator light incident surface 13 as the center, the luminance is highest at the center of the integrator light incident surface 13. Since the light entering the integrator light incident surface 13 is averaged inside the integrator 14, the luminance distribution on the integrator light outgoing surface 15 becomes uniform.

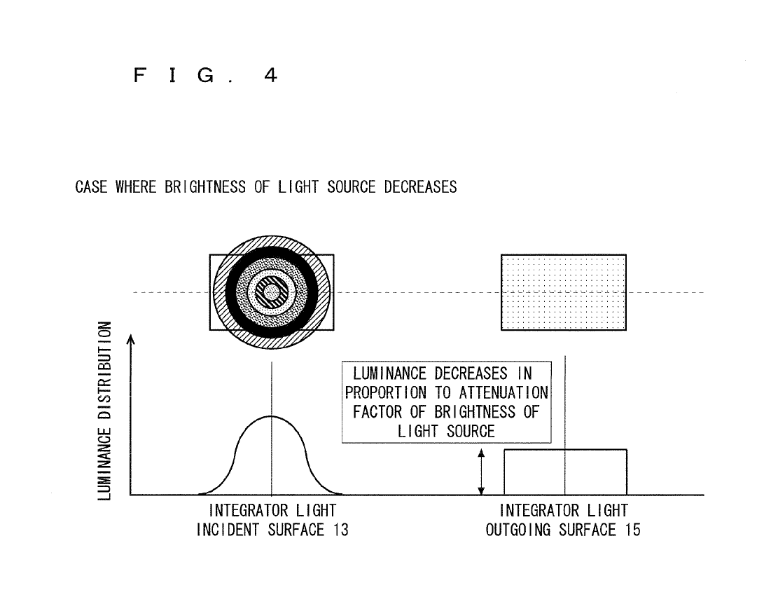

FIG. 4 shows luminance distributions in a case where the brightness of the lamp light source 10 decreases without changing the position of the light source or the condensing position on the integrator light incident surface 13. The luminance on the integrator light outgoing surface 15 decreases in proportion to the attenuation factor of the brightness of the lamp light source 10.

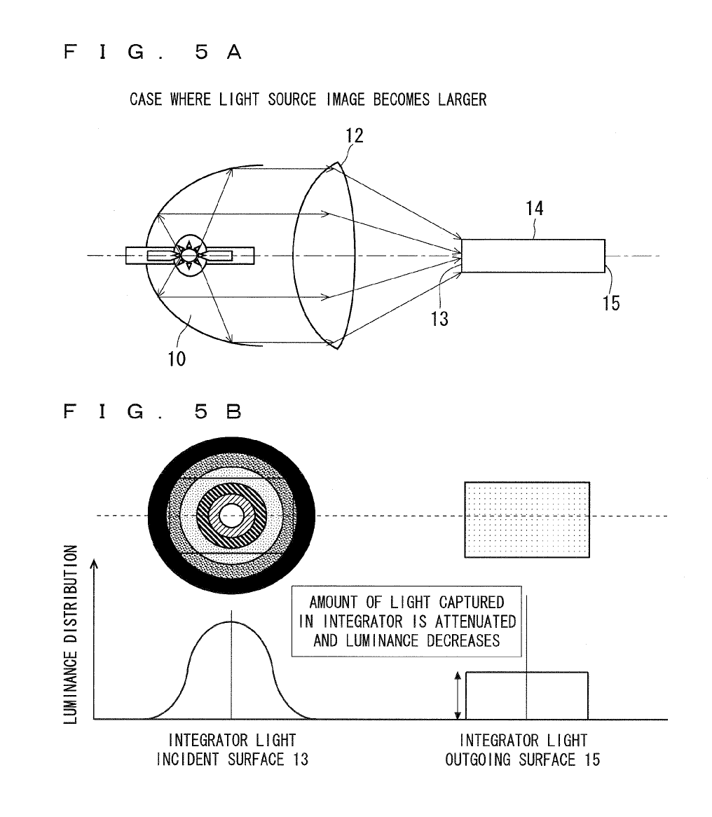

On the other hand, FIGS. 5A and 5B show luminance distributions in a case where the luminance distribution of light condensed onto the integrator light incident surface 13 becomes larger, in other words, a light source image becomes larger without changing the brightness of the lamp light source 10. In this case, since the amount of light captured in the integrator 14 is attenuated, the luminance on the integrator light outgoing surface 15 decreases.

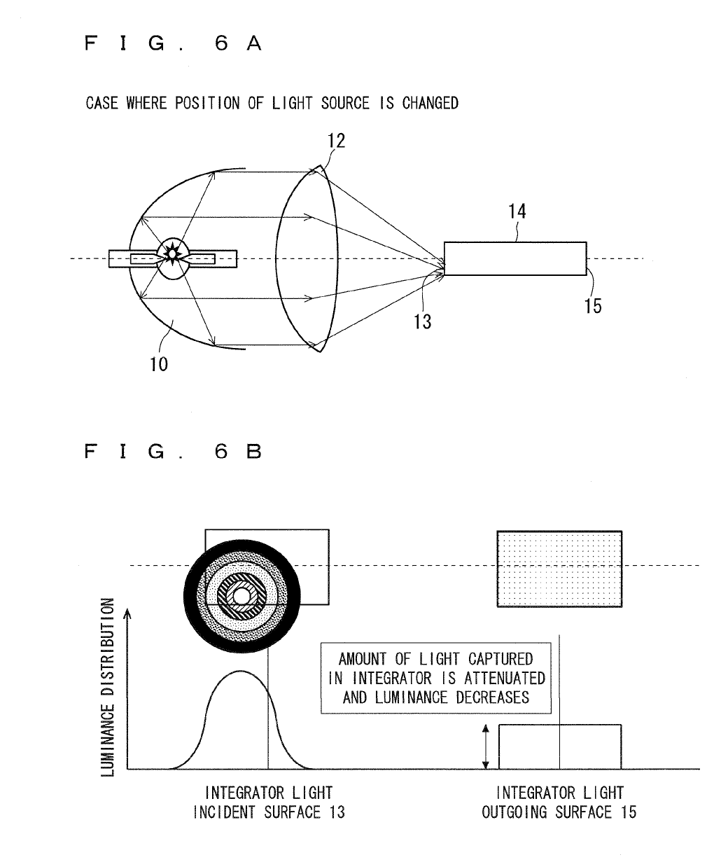

FIGS. 6A and 6B show a case where the position of the lamp light source 10 is changed while the brightness of the lamp light source 10 is not changed. In this case, since the position of the luminance distribution on the integrator light incident surface 13 is changed and the amount of light captured in the integrator 14 is attenuated, the luminance on the integrator light outgoing surface 15 decreases.

As shown in FIGS. 5A, 5B, 6A, and 6B, in the case where the size of the light source image is changed or the position of the lamp light source 10 is changed, the luminance on the integrator light outgoing surface 15 is changed even if the brightness of the light source is not changed. For this reason, in such a case, the measurement of the luminance of the leak light of the lamp light source 10 does not reflect the luminance change on the screen 22.

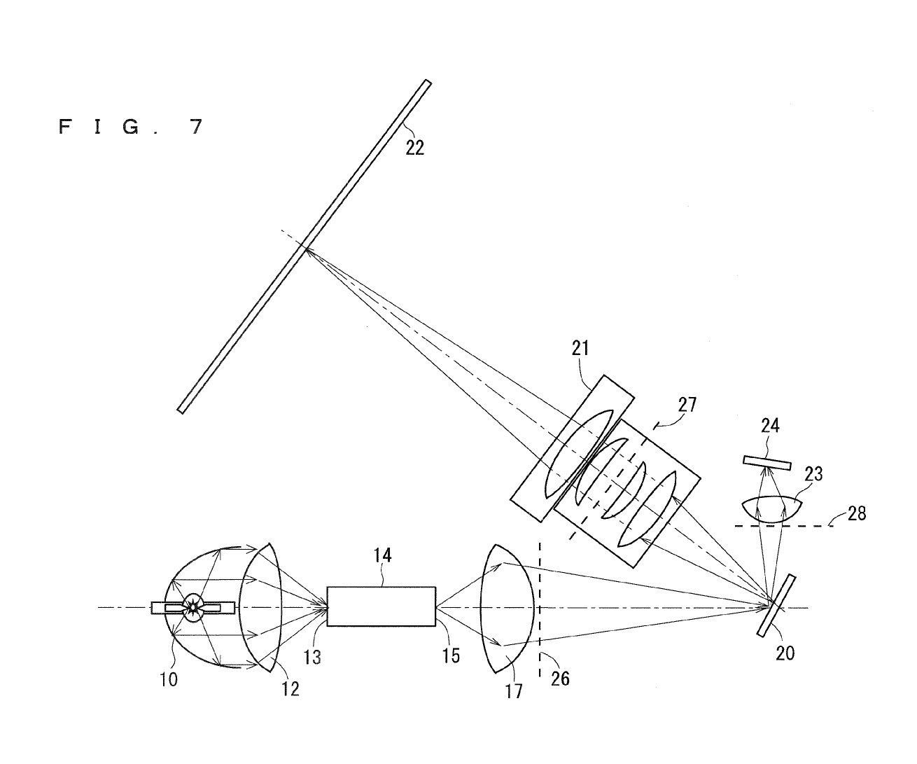

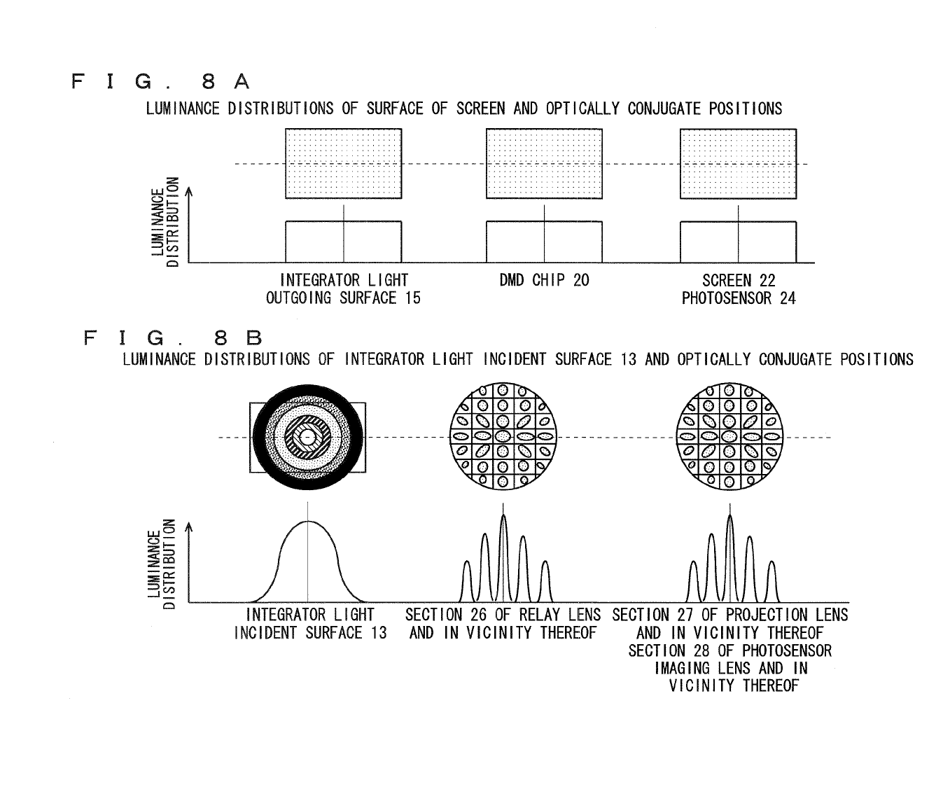

FIG. 7 shows an optical imaging relation of the projection display device of the first preferred embodiment, where the color wheel 16 and the internal total reflection prism 19, and the like are omitted for clear explanation. In FIG. 7, a surface of the DMD chip 20 and the integrator light outgoing surface 15 have an optically conjugate relation with the screen 22. The uniform luminance distribution on the integrator light outgoing surface 15 is imaged on the surface of the DMD chip 20 through the relay lens 17. Further, the uniform luminance distribution imaged on the surface of the DMD chip 20 is imaged on the surface of the screen 22 through the projection lens 21. Therefore, the integrator light outgoing surface 15, the DMD chip 20, and the screen 22 have the same luminance distribution. FIGS. 8A and 8B show a relation between the optically conjugate position and the luminance distribution. In FIG. 8A, the upper view shows the respective luminance distributions of the DMD chip 20, the screen 22, and the photosensor 24 which are disposed at the positions which are optically conjugate to the screen, and the lower view shows the respective luminance distributions taken along the dotted line of the upper view. The DMD chip 20, the screen 22, and the photosensor 24 have the same uniform luminance distributions.

In FIG. 8B, the upper view shows the luminance distributions on a condensing position of the lamp light source 10, i.e., the integrator light incident surface 13 and the positions which are optically conjugate to the integrator light incident surface 13, and the lower view shows the luminance distributions taken along the dotted line of the upper view. Herein, the respective luminance distributions of a section 26 of the relay lens and in the vicinity thereof, a section 27 of the projection lens and in the vicinity thereof, and a section 28 of the photosensor imaging lens and in the vicinity thereof are discrete ones like a grid since the condensed image of light from the lamp light source 10 is segmentalized depending on the number of reflections and the direction thereof inside the integrator 14. Since this discrete luminance distributions are changed by the size and position of the light source, even if the luminance is measured with the photosensor 24 disposed on these positions, it is impossible to obtain an accurate correlation with the luminance on the screen 22.

Though a value correlated with the luminance of the screen 22 can be obtained when the luminance is measured at the position which is optically conjugate to the screen 22, there arises a problem of interference with a display video image if the photosensor 24 is disposed on the integrator light outgoing surface 15 or the surface of the DMD chip 20. Then, instead of disposing the photosensor 24 on the main optical path, by imaging the off light of the DMD chip 20 on the photosensor 24 through the photosensor imaging lens 23, it is possible to acquire sensor values correlated with the luminance change and the hue change of the screen 22 without interfering with the main optical path while the photosensor 24 is disposed at the position which is optically conjugate to the screen 22. Therefore, it is possible to accurately correct the luminance change and the hue change of the screen 22.

### <Effects>

Since the projection display device of the first preferred embodiment comprises the light source (lamp light source 10), the light modulator (DMD chip 20) for modulating the emitted light in response to the input signal, the illumination optical system for emitting light from the lamp light source 10 to the DMD chip 20, the projection optical system (projection lens 21) for projecting the light modulated by the DMD chip 20 onto the screen 22, and the photosensor 24 disposed on the optical path of branch light which is branched outside of the main optical path from the lamp light source 10 to the screen 22, in the vicinity of the position which is optically conjugate to the screen surface of the screen 22, it is possible to accurately detect the luminance change and the hue change of the screen 22 without interfering with any display video image.

Further, in the projection display device of the first preferred embodiment, since the photosensor 24 is disposed on the optical path of the off light of the DMD chip 20, it is possible to detect the luminance change and the hue change of the screen 22 without interfering with any display video image.

### The Second Preferred Embodiment

### <Constitution>

Since the photosensor 24 can accurately detect the luminance change and the hue change on the screen 22 when the photosensor 24 is disposed at the position which is optically conjugate to the screen 22, the photosensor 24 may be disposed on an optical path of leak light of the illumination optical system or the projection lens 21, not limited to the optical path of the off light of the DMD chip 20 as discussed in the first preferred embodiment. In a projection display device of the second preferred embodiment, leak light of the reflection mirror 18 is used to provide a position which is optically conjugate to the integrator light outgoing surface 15 and the photosensor 24 is disposed at the position.

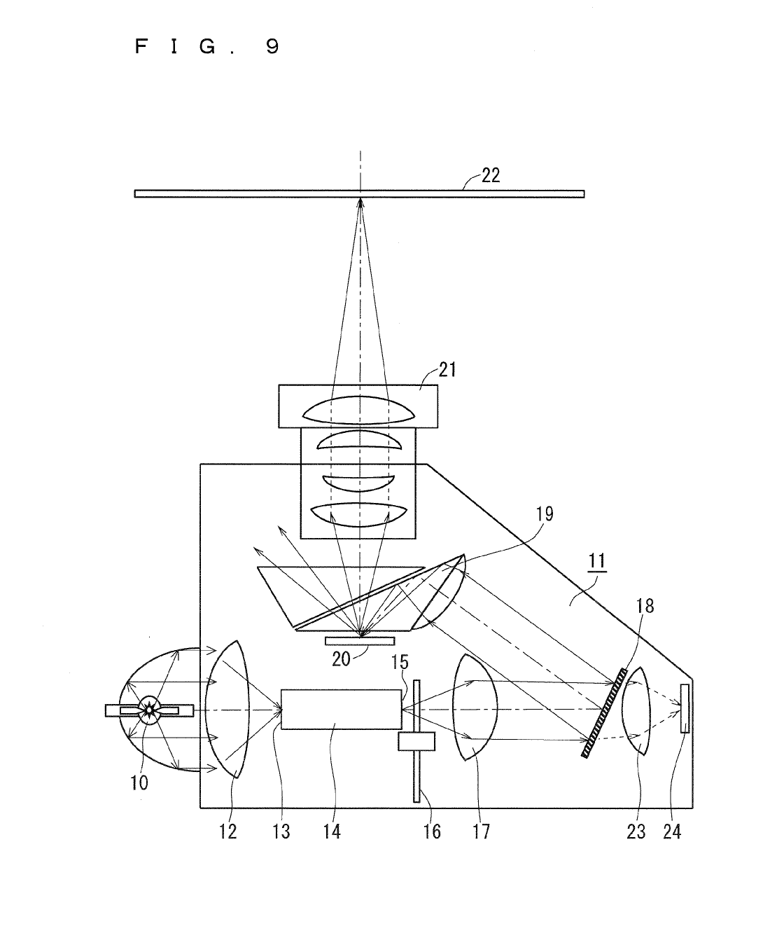

FIG. 9 is a structural diagram showing a projection display device in accordance with the second preferred embodiment of the present invention. In the projection display device of the second preferred embodiment, the photosensor imaging lens 23 is provided behind the reflection mirror 18 and transmission light (leak light) of the reflection mirror 18 is imaged on the photosensor 24.

By designing the photosensor imaging lens 23 so that the integrator light outgoing surface 15 and the photosensor 24 have an optically conjugate relation, the photosensor 24 can acquire photosensor values corresponding to the luminance change and the hue change of the screen 22. Therefore, it is possible to accurately correct the luminance change and the hue change on the screen 22.

The disposing position of the photosensor 24 has only to be a position which is optically conjugate to the screen inside the projector, and not limited to a post-stage of the reflection mirror 18.

### <Effects>

Since the projection display device of the second preferred embodiment comprises the light source (lamp light source 10), the light modulator (DMD chip 20) for modulating the emitted light in response to the input signal, the illumination optical system for emitting light from the lamp light source 10 to the DMD chip 20, the projection optical system (projection lens 21) for projecting the light modulated by the DMD chip 20 onto the screen 22, and the photosensor 24 disposed on the optical path of branch light which is branched outside of the main optical path from the lamp light source 10 to the screen 22, in the vicinity of the position which is optically conjugate to the screen surface of the screen 22, it is possible to accurately detect the luminance change and the hue change of the screen 22 without interfering with any display video image.

Further, in the projection display device of the second preferred embodiment, since the photosensor 24 is disposed on the optical path of the leak light of the illumination optical system or the projection optical system, it is possible to detect the luminance change and the hue change of the screen 22 without interfering with any display video image.

### The Third Preferred Embodiment

### <Constitution>

In the first preferred embodiment, the photosensor 24 is disposed at the position which is optically conjugate to the screen 22, by using the photosensor imaging lens 23. If the photosensor 24 and the screen 22 do not have an optically conjugate relation, the luminance distribution in the photosensor 24 becomes discrete.

Then, in the third preferred embodiment, instead of disposing the photosensor 24 at the position which is optically conjugate to the screen 22, uniformizing means for uniformizing the discrete luminance distribution is provided.

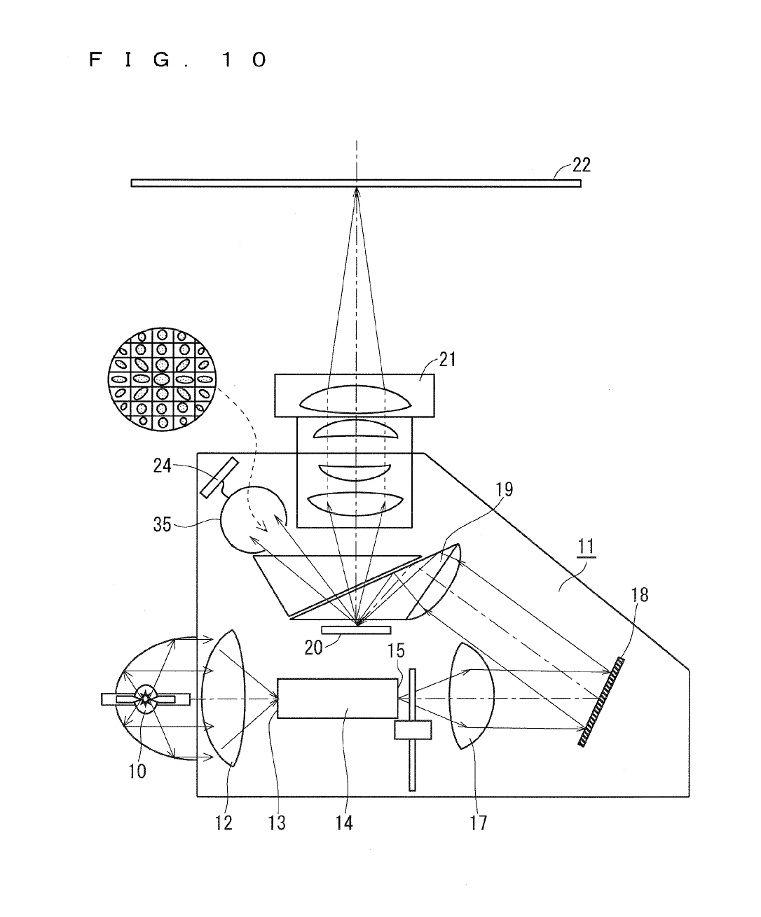

FIG. 10 is a structural diagram showing a projection display device in accordance with the third preferred embodiment of the present invention. The projection display device of the third preferred embodiment comprises an integrating sphere 35 serving as the uniformizing means receiving the off light of the DMD chip 20 and the photosensor 24 for measuring luminance of the integrating sphere 35.

The off light outgoing from the DMD chip 20 is captured into the integrating sphere 35 disposed inside the projector unit 11. The captured light is uniformized by the integrating sphere 35 and the intensity of the light is measured by the photosensor 24. Though the luminance distribution of the off light is discrete and not uniform at the point in time when the off light is captured into the integrating sphere 35, the integrating sphere 35 averages the luminance distribution, and it thereby becomes possible to acquire a photosensor value which accurately reflects the luminance change on the screen 22 and possible to accurately correct the luminance and the hue.

### <Variation>

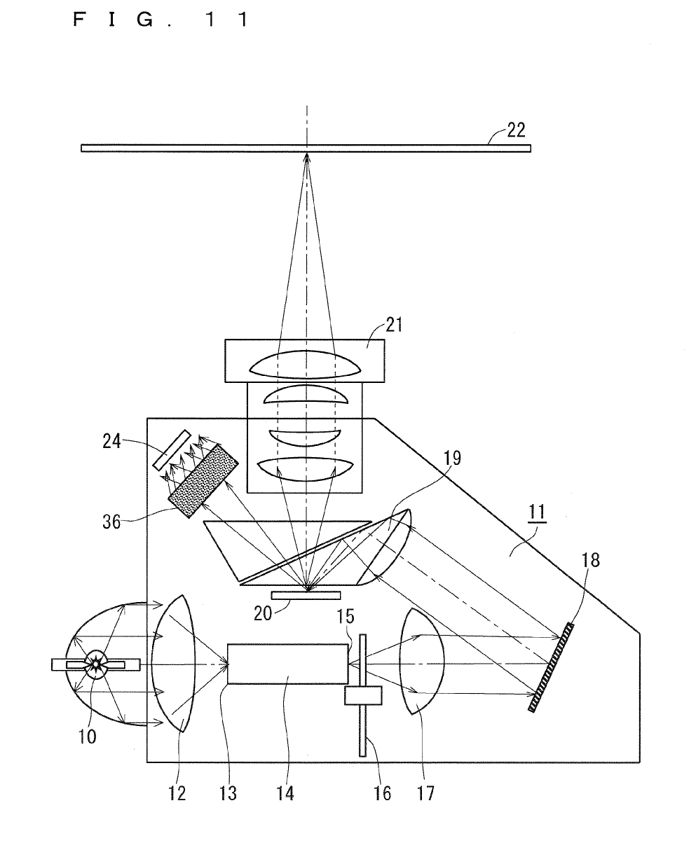

As the uniformizing means for uniformizing the discrete luminance distribution, other than the integrating sphere 35, a diffusion plate 36 shown in FIG. 11 may be used to produce the same effect.

### <Effects>

Since the projection display device of the third preferred embodiment comprises the light source (lamp light source 10), the light modulator (DMD chip 20) for modulating the emitted light in response to the input signal, the illumination optical system for emitting light from the lamp light source 10 to the DMD chip 20, the projection optical system (projection lens 21) for projecting the light modulated by the DMD chip 20 onto the screen 22, the uniformizing means for uniformizing the luminance distribution of the branch light branched outside of the main optical path from the lamp light source 10 to the screen 22, and the photosensor 24 on which the light uniformized by the uniformizing means is incident, it is possible to accurately detect the luminance change and the hue change of the screen 22 without interfering with any display video image.

Further, in the projection display device of the third preferred embodiment, since the uniformizing means is the integrating sphere 35, the photosensor 24 measures the luminance distribution of the off light uniformized by the integrating sphere 35, and it is thereby possible to accurately detect the luminance change and the hue change of the screen 22.

Alternatively, in the projection display device of the third preferred embodiment, since the uniformizing means is the diffusion plate 36, the photosensor 24 measures the luminance distribution of the off light uniformized by the diffusion plate 36, and it is thereby possible to accurately detect the luminance change and the hue change of the screen 22.

Further, since the projection display device of the third preferred embodiment comprises the uniformizing means for uniformizing the luminance distribution of the off light of the light modulator (DMD chip 20), the photosensor 24 measures the luminance distribution of the off light uniformized by the uniformizing means, and it is thereby possible to accurately detect the luminance change and the hue change of the screen 22.

### The Fourth Preferred Embodiment

In the second preferred embodiment, the leak light of the reflection mirror 18 is imaged on the photosensor 24, and the photosensor 24 and the screen 22 have an optically conjugate relation. In the fourth preferred embodiment, instead of disposing the photosensor 24 at the position which is optically conjugate to the screen 22 in the constitution of the second preferred embodiment, uniformizing means for uniformizing the luminance distribution of the leak light of the reflection mirror 18 is provided.

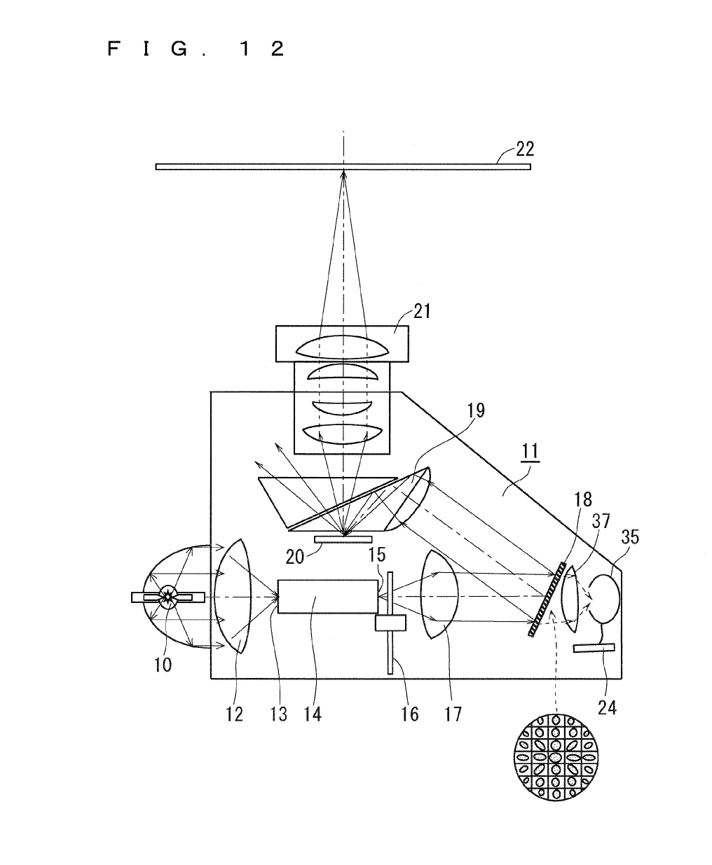

FIG. 12 is a structural diagram showing a projection display device in accordance with the fourth preferred embodiment of the present invention. In the projection display device of the fourth preferred embodiment, the leak light of the reflection mirror 18 is condensed onto the integrating sphere 35 by using a condensing lens 37, the integrating sphere 35 uniformizes the luminance distribution, and the photosensor 24 measures the intensity of the light.

The condensing lens 37 is provided to take the leak light of the reflection mirror 18 into the integrating sphere 35, without regard to an imaging relation.

Thus, in the projection display device of the fourth preferred embodiment, all the discrete luminance distributions are captured and averaged in the integrating sphere 35, and it thereby becomes possible to acquire a photosensor value which accurately reflects the luminance change on the screen 22 and possible to accurately correct the luminance and the hue.

### <Variation>

As the uniformizing means for uniformizing the discrete luminance distribution, other than the integrating sphere 35, the diffusion plate 36 may be used to produce the same effect.

### <Effects>

Since the projection display device of the fourth preferred embodiment comprises the light source (lamp light source 10), the light modulator (DMD chip 20) for modulating the emitted light in response to the input signal, the illumination optical system for emitting light from the lamp light source 10 to the DMD chip 20, the projection optical system (projection lens 21) for projecting the light modulated by the DMD chip 20 onto the screen 22, the uniformizing means for uniformizing the luminance distribution of the branch light branched outside of the main optical path from the lamp light source 10 to the screen 22, and the photosensor 24 on which the light uniformized by the uniformizing means is incident, it is possible to accurately detect the luminance change and the hue change of the screen 22 without interfering with any display video image.

Further, in the projection display device of the fourth preferred embodiment, since the uniformizing means is the integrating sphere 35, the photosensor 24 measures the luminance distribution of the off light uniformized by the integrating sphere 35, and it is thereby possible to accurately detect the luminance change and the hue change of the screen 22.

Alternatively, in the projection display device of the fourth preferred embodiment, since the uniformizing means is the diffusion plate 36, the photosensor 24 measures the luminance distribution of the off light uniformized by the diffusion plate 36, and it is thereby possible to accurately detect the luminance change and the hue change of the screen 22.

Further, in the projection display device of the fourth preferred embodiment, since the branch light is the leak light of the illumination optical system or the projection lens 21, it is possible for the photosensor 24 to detect the luminance change and the hue change of the screen 22 without interfering with any display video image.

### The Fifth Preferred Embodiment

### <Constitution>

Though the lamp light source 10 is used in the first to fourth preferred embodiments, a solid-state light source such as an LED, a laser, or the like may be used to produce the same effect. In the fifth preferred embodiment, an LED light source unit is used, instead of the lamp light source.

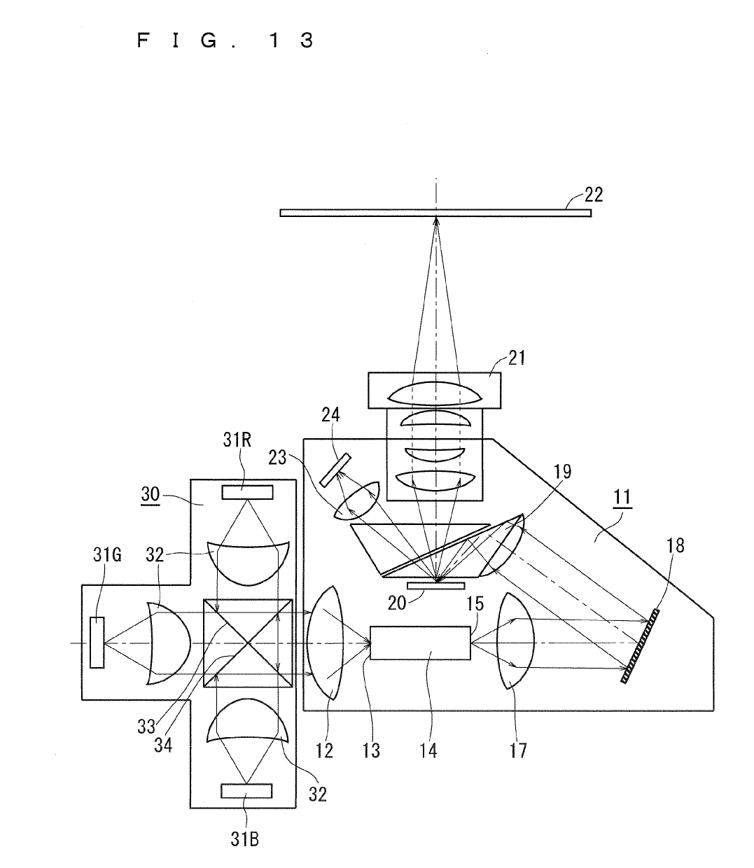

FIG. 13 is a structural diagram showing a projection display device in accordance with the fifth preferred embodiment of the present invention. In the projection display device of the fifth preferred embodiment, an LED light source unit 30 is adopted, instead of the lamp light source 10, in the constitution of the first preferred embodiment, and the other constituent elements are the same as those in the first preferred embodiment.

The LED light source unit 30 comprises a red LED 31R, a green LED 31G, and a blue LED 31B. A collimator lens 32 for collimating source light into parallel light is provided in a post-stage of each of the red LED 31R, the green LED 310, and the blue LED 31B. The parallel light passing through the collimator lens 32 enters dichroic mirrors 33 and 34. The dichroic mirror 33 reflects red light and allows light having any other wavelength to pass therethrough, and the dichroic mirror 34 reflects blue light and allows light having any other wavelength to pass therethrough. As a result, the red light, the blue light, and the green light are combined and enter the condenser lens 12 in the projector unit 11.

Further, though the case where the LED light source unit 30 is applied in the first preferred embodiment is shown in FIG. 13, the LED light source unit 30 may be applied in the second to fourth preferred embodiments.

### <Effects>

In the projection display device of the fifth preferred embodiment, since the light source is the LED, it is possible to reduce power consumption.

While the invention has been shown and described in detail, the foregoing description is in all aspects illustrative and not restrictive. It is therefore understood that numerous modifications and variations can be devised without departing from the scope of the invention.

What is claimed is:

1. A projection display device comprising:
a light source;
a light modulator for modulating emitted light in response to an input signal;
an illumination optical system for emitting light from said light source to said light modulator;
a projection optical system for projecting light modulated by said light modulator onto a screen; and
a photosensor disposed on an optical path of branch light which is branched outside of a main optical path from said light source to said screen, in the vicinity of a position which is optically conjugate to a screen surface of said screen.

2. A projection display device comprising:
a light source;
a light modulator for modulating emitted light in response to an input signal;
an illumination optical system for emitting light from said light source to said light modulator;
a projection optical system for projecting light modulated by said light modulator onto a screen;
uniformizing means for uniformizing a luminance distribution of branch light branched outside of a main optical path from said light source to said screen; and
a photosensor on which light uniformized by said uniformizing means is incident.

3. The projection display device according to claim 2, wherein
said uniformizing means is an integrating sphere.

4. The projection display device according to claim 2, wherein
said uniformizing means is a diffusion plate.

5. The projection display device according to claim 1, wherein
said branch light is off light of said light modulator.

6. The projection display device according to claim 2, wherein
said branch light is off light of said light modulator.

7. The projection display device according to claim 1, wherein
said branch light is leak light of said illumination optical system or said projection optical system.

8. The projection display device according to claim 2, wherein
said branch light is leak light of said illumination optical system or said projection optical system.

9. The projection display device according to claim 1, wherein
said light source is an LED.

10. The projection display device according to claim 2, wherein
said light source is an LED.
